(19) United States
(12) Patent Application Publication
(10) Pub. No.: US 2012/0202014 A1
(43) Pub. Date: Aug. 9, 2012

(54) TAPE HAVING ADHESIVE FILL STRIP AND SYSTEM FOR MANUFACTURING THE SAME

(75) Inventors: James Howard MERRITT, Jr., Waxhaw, NC (US); Jeffrey Scott REBH, Rock Hill, SC (US)

(73) Assignee: INNOVATIVE TAPE SOLUTIONS, INC., CHARLOTTE, NC (US)

(21) Appl. No.: 13/102,548

(22) Filed: May 6, 2011

Related U.S. Application Data
(60) Provisional application No. 61/331,946, filed on May 6, 2010.

(51) Int. Cl. C09J 7/02; B32B 41/00

(52) U.S. Cl. 428/189; 156/378

(57) ABSTRACT

An adhesive tape including an adhesive side and a fill strip arranged on the adhesive side covering a center portion of the adhesive side and leaving exposed side portions of the adhesive side on either side of the fill strip. A system for applying a fill strip to an adhesive tape including an adhesive tape supply roll, a fill strip supply roll, a centering guide and at least one tensioner.

### CROSS-REFERENCE TO RELATED APPLICATION

This non-provisional application claims priority to U.S. Provisional Application No. 61/331,946 filed May 6, 2010 and entitled “TAPE HAVING ADHESIVE FILL STRIP AND SYSTEM FOR MANUFACTURING THE SAME,” the contents of which are incorporated by reference herein.

### TECHNICAL FIELD AND BACKGROUND

Provided herein are adhesive tapes for use in sealing boxes having shortened flaps, and more particularly, to adhesive tapes having a fill strip covering a portion of the tape's adhesive, and systems for applying a fill strip to adhesive tape in a box sealing machine.

Corrugated cardboard is commonly used as the packaging container material of choice due to its advantageous material properties of lightweight, strength, collapsibility, ease of handling and recyclability, among others. Corrugated cardboard boxes, referred to herein simply as “boxes,” are typically delivered pre-manufactured and in a collapsed state to facilitate shipping, and are assembled on-site as needed. Assembly and sealing of the boxes may be performed manually, with automated systems, or a combination of both. In a specific embodiment, and in which the present invention finds particular application, box closing and sealing machines are used to fold closed opposing tops flaps of a box subsequent to packing, and a taping head is used to apply a length of pressure-sensitive adhesive tape to portions of the closed flaps and sides of the box to maintain the flaps in a closed state.

While corrugated cardboard has a relatively low cost as compared to other types of container materials, the cost of corrugated cardboard as compared to sealing tape is relatively high. For example, by shortening opposing flaps of a box from flush to about a several inch gap therebetween, significant material cost savings can be achieved. In this regard, it is known in the art to “shorten” the opposing flaps to reduce the amount of corrugated cardboard required per box. While advantageous in terms of material and cost savings, shortened flaps require alternative methods for sealing closed. In one prior art sealing method, two spaced-apart taping heads are used to apply a independent lengths of tape to each of the opposing flaps. While advantageous in terms of material savings, spaced-apart tape strips disadvantageously leave a gap between opposing flaps that potentially leaves articles within the box susceptible to damage, as well as disadvantageously add to the cost and complexity of the box closing and sealing machine. Another prior art sealing method includes using a single, wide strip of sealing tape to simultaneously cover portions of the shortened flaps as well as bridge the gap therebetween. While advantageous in that the gap is covered, thus protecting the articles therein, the underside of the adhesive tape is exposed to the contents of the box, often disadvantageously causing the articles and packing materials to stick to the underside of the tape.

In this regard, it would be desirable to realize the material and cost savings of using shortened box flaps while overcoming the disadvantages of the prior art sealing methods.

### BRIEF DESCRIPTION OF THE DRAWINGS

Features, aspects and advantages of the present invention are understood when the following detailed description of the invention is read with reference to the accompanying drawings, in which:

FIG. 1 is an illustration of an exemplary adhesive tape and corresponding center fill strip shown separated;

FIG. 2 is an illustration of the fill strip of FIG. 1 shown applied to the adhesive tape of FIG. 1;

FIG. 3 is a schematic diagram illustrating the use of the adhesive tape of FIG. 2 to seal opposing shortened box flaps;

FIG. 4 is a schematic side elevation view of a system for applying a fill strip to an adhesive tape; and

FIG. 5 is a top plan view of the sealing system of FIG. 4.

### DETAILED DESCRIPTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

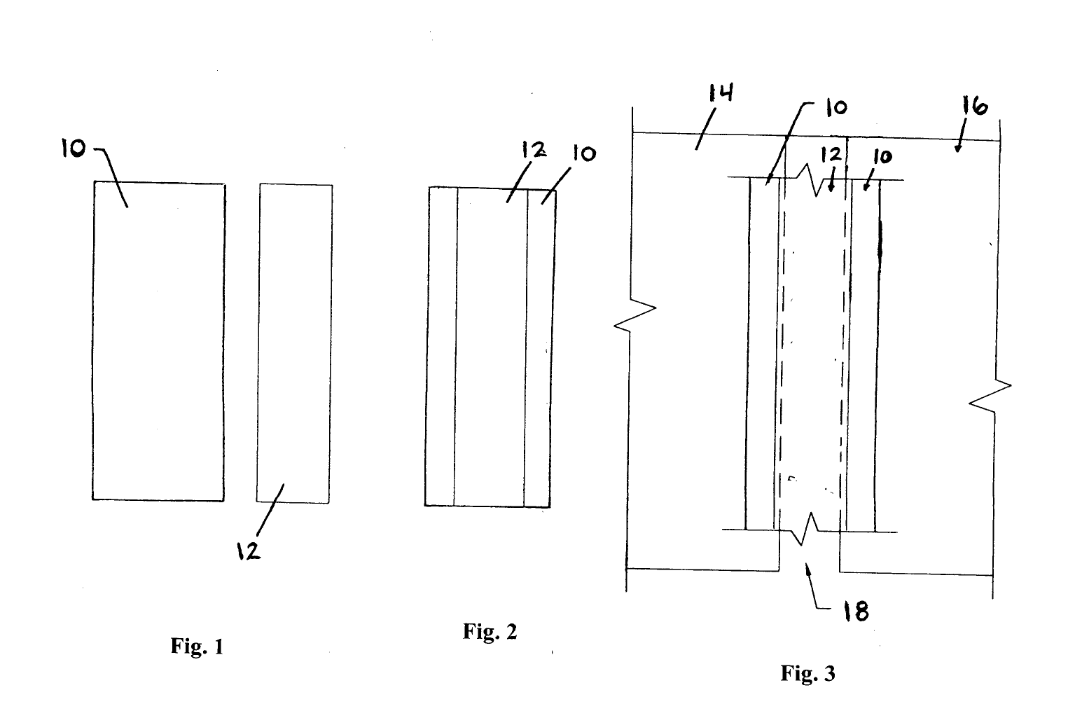

Referring to FIGS. 1-2, an adhesive tape and associated center fill strip are shown generally at reference numerals 10 and 12, respectively. Although tape 10 is referred to throughout the specification as an “adhesive tape,” it is intended that the tape may be one of many known varieties of backing materials coated with various types of adhesives known to those skilled in the art. In an exemplary embodiment, adhesive tape 10 is a pressure sensitive tape including a pressure sensitive adhesive coated onto a backing film such as paper, plastic film, cloth or metal foil, among others. Known to those skilled in the art, pressure sensitive tapes are sticky (tacky) without requiring heat or solvent for activation and adhere with light pressure. These types of tapes also typically require a release agent on their backing to allow release in roll form.

Adhesive tape 10 may have any width and length, with the width corresponding to the gap distance between the shortened box flaps and the amount of tape/flap overlap desired. In an exemplary embodiment, adhesive tape 10 has a width greater than about 4 inches, more preferably about 6 inches, to accommodate a gap of about 4 inches between shortened flaps. Adhesive tape 10 may have any length, and in sealing systems, is preferably provided in long lengths in roll form that is cut to size during application. Fill strip 12 has a width corresponding to its respective adhesive tape 10 such that about a 1-2 inch gap is provided on either side of fill strip 12 for adequate adherence to the flaps.

Referring specifically to FIG. 2, fill strip 12 is positioned substantially centered along the length of adhesive 10 such that an equal width of adhesive remains uncovered on either side of fill strip 12. For universal application, fill strip 12 runs substantially the length of adhesive tape 10. For customized applications in which the determining box length is known, various fill strips 12 may be applied in discrete lengths along the length of adhesive tape 10 such that the length of the gap is covered with fill strip 12 while the sides are free of fill strip 12 for greater adherence. Fill strip 12 may be made from any material suitable for adhering to the adhesive of tape 10 including, but not limited to, backing, paper, plastic and cloth, with or without its own adhesive. Fill strip 12 may further include any indicia printed thereon for labeling or advertising purposes, among other purposes. Thus, in a particular embodiment, adhesive tape 10 may be clear or visually transparent and thus capable of universal application, while fill strip 10 may include customized printing, labeling and/or coloring.

Referring to FIG. 3, shortened, opposing box flaps are illustrated at reference numerals 14 and 16 and define gap 18 therebetween having a gap distance greater than flush. Fill strip 12 has a width about corresponding to gap distance 18, and alternatively as shown, has a width greater than gap distance 18 to provide slight fill strip overlap. Fill strip overlap relaxes the required tape application accuracy and ensures covering of exposed adhesive. As stated above, it is intended that gap distance and corresponding tape and fill strip widths may vary.

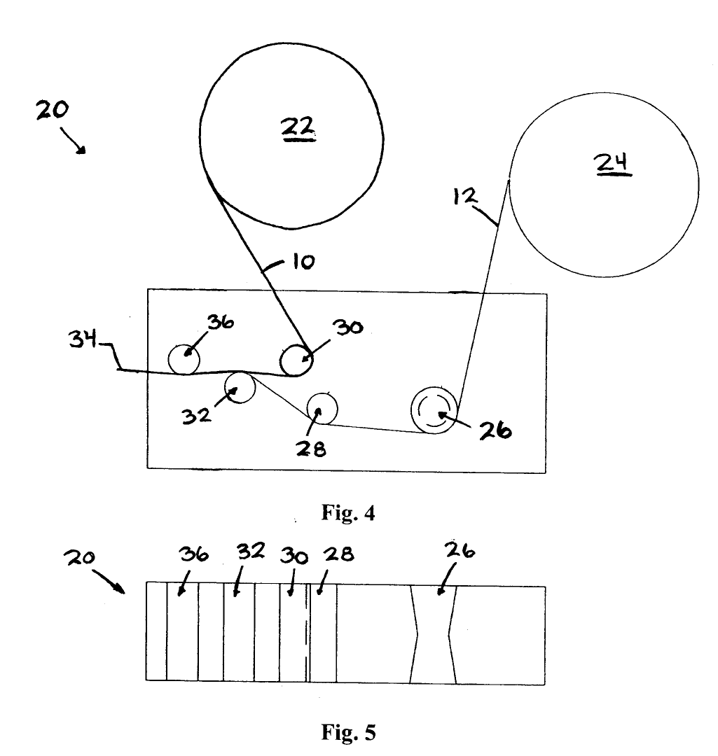

Referring to FIGS. 4-5, a system for applying fill strip 12 to adhesive tape 10 is provided, such as for use in conjunction with an automated box closing and sealing system. System 20 includes adhesive tape supply roll 22 and fill strip supply roll 24 each for supply long lengths of predetermined widths of materials. Adhesive tape 10 and fill strip 12 are supplied through the rotation of rolls 22 and 24, wherein each of their rotational speeds are determined based on demand from pulling forces downstream. Fill strip 12 is supplied to adhesive tape 10 over rotating fill strip centering guide 26 and rotating tensioner 28 to ensure proper centering with respect to the width of adhesive tape 10 and apply a force to fill strip 12 to maintain it in tension, respectively. As best shown in FIG. 5, centering guide 26 tapers along its length from opposing ends toward its center such fill strip 12 is guided towards center. Tensioner 28 ensures that the surfaces of fill strip 12 and adhesive tape 10 are combined flush without overlap or buckling.

Adhesive tape 10 is supplied through roll 22 under tension provided by rotating tensioner 30. Tape 10 and fill strip 12 are combined at low surface energy roller 32 operable for applying a light pressure to ensure proper adherence between tape 10 and fill strip 12. The combined strip illustrated at 34 is further subject to tension provided through rotating tensioner 36. Tape and fill strip tangent points of tensioners 30 and 36 and energy roller 32 are preferably out of linear alignment to ensure contact with each roller for proper adherence and tension.

System 20 may be used in conjunction with a conventional box closing and sealing system employing a taping head, wherein the tape supply includes a roll of adhesive tape having a center fill strip as provided herein, or as produced by system 20. Known to those skilled in the art, box sealing machines include at least an upper taping head for applying a length of pressure-sensitive adhesive tape to a box driven through a system along a box guide path. Conventional systems are further known for folding the box flaps so as to close the box in combination with the at least one taping head in a known manner. Typical closing systems include members for engaging and folding the minor and major flaps of a box as the box moves forward so as to urge them downward to their closed positions. After the folding is complete, the taping head seals the top of the box with a length of adhesive tape applied to the upper major side of the shortened flaps in a manner shown in FIG. 3.

Conventional systems may further include systems for sensing the motion of the box along the guide path, feed controls, conveyors, controllers and driving means, among other components.

While adhesive tapes and sealing systems have been described with reference to specific embodiments and examples, it is envisioned that various details may be changed without departing from the scope of the invention. Furthermore, the foregoing description of the preferred embodiments and best mode for practicing the invention are provided for the purpose of illustration only and not for the purpose of limitation.

What is claimed is:

1. An adhesive tape, comprising:
an adhesive side; and
a fill strip arranged on the adhesive side covering a center portion of the adhesive side and leaving exposed side portions of the adhesive side on either side of the fill strip.

2. The adhesive tape according to claim 1, wherein the fill strip runs substantially the length of the adhesive tape.

3. The adhesive tape according to claim 1, wherein the side portions are entirely separated by the fill strip.

4. The adhesive tape according to claim 1, wherein the fill strip is non-adhesive.

5. The adhesive tape according to claim 1, wherein the side portions have substantially equal widths.

6. The adhesive tape according to claim 1, wherein the fill strip has a width such that the side portions have a width of about 1-2 inches

7. The adhesive tape according to claim 1, wherein the adhesive tape has a width of about 4 inches and the fill strip has a width less than about 2 inches.

8. The adhesive tape according to claim 1, wherein the adhesive tape has a width of about 6 inches and the fill strip has a width less than about 4 inches.

9. The adhesive tape according to claim 1, wherein the adhesive tape is visually transparent and the fill strip includes indicia thereon visible through the adhesive tape.

10. A system for applying a fill strip to an adhesive tape, comprising:
an adhesive tape supply roll for supplying a continuous length of the adhesive tape;
a fill strip supply roll for supplying a continuous length of the fill strip;
a centering guide for centering the fill strip with respect to a width of an adhesive side of the adhesive tape;
a first tensioner for applying a force to the fill strip to maintain the fill strip in tension and ensure adherence between the fill strip and the adhesive tape; and
a second tensioner for subjecting the adhered fill strip and adhesive tape to tension.

11. The system according to claim 10, wherein the centering guide tapers along its length from its opposing ends toward its center such that the fill strip is guided towards center.

12. The system according to claim 10, wherein adhesive tape and fill strip tangent points of the first and second tensioners are out of linear alignment to ensure contact and proper adherence and tension.

13. The system according to claim 10, wherein the fill strip is arranged on the adhesive side of the adhesive tape covering a center portion of the adhesive side and leaving exposed side portions of the adhesive side on either side of the fill strip.
